(19) United States
(12) Patent Application Publication
(10) Pub. No.: US 2011/0029401 A1
(43) Pub. Date: Feb. 3, 2011

(54) Method Of Providing Online House Or Office Décor Related Service

(76) Inventors: Frances Champe Granger, Richmond, VA (US); Roger Lucien Bouchard, Richmond, VA (US)

Correspondence Address: Eli Weiss, Esq.;Oakwood Law Group, LLP, 14 Bond Street -- SUITE 386, Great Neck, NY, 11021, US

(21) Appl. No.: 12/844,963

(22) Filed: Jul. 28, 2010

Related U.S. Application Data
(60) Provisional application No. 61/229,052, filed on Jul. 28, 2009.
(60) Provisional application No. 61/235,939, filed on Aug. 21, 2009.
(60) Provisional application No. 61/292,955, filed on Jan. 7, 2010.

(51) Int. Cl. G06Q 30/00

(52) U.S. Cl. 705/26.4; 705/26.61; 705/26.7; 705/27.2

(57) ABSTRACT

A method for an on-line home decor service community includes: providing a database; entering pictures or data into the database that provides a definition for one or more interior or exterior spaces, and décor-related items; indicating one or more of the items to renew or replace or change; offering a selection of pre-packaged or pre-rendered designs and a price for the indicated item; offering, contests, discounts, advise, and product information as a part of the community and offering access to the database from a browser-based device. The décor-related items include custom room or space designs, furniture arrangement, flooring selection, lighting, art and accessories plans, draperies selection, paint color selection, fixtures, plantings, architectural embellishments, landscaping and finishes item in a residence or office space.

### REFERENCE TO RELATED APPLICATIONS

This patent application claims the benefit of and is a continuation in part of U.S. Provisional Application No. 61/229,052 filed on Jul. 28, 2009, the disclosure of which is incorporated herein by reference in its entirety; and is a continuation in part of U.S. Provisional Application No. 61/235,939 filed on Aug. 21, 2009, the disclosure of which is incorporated herein by reference in its entirety; and is a continuation in part of U.S. Provisional Application No. 61/292,955 filed on Jan. 7, 2010, the disclosure of which is incorporated herein by reference in its entirety.

### BACKGROUND OF THE INVENTION

1. Field of the Invention

The present invention relates generally to a remotely accessible system and database where the system is the application that is created behind which sits a database capable of storing interior designs and interior design information. More specifically the database can be accessed through the internet or any web enabled device. Additionally, the interior design information can be in the form of text, photographs, images, videos, or other data. The interior design information can be tailored to interior or exterior spaces, residential or commercial. Additionally, the interior design information can be separated into categories including room furnishings, paint samples, flooring, landscape, etc.

2. Description of Related Art

Methods which are directed toward a remotely accessible database for storing information that relates to utilizing space, design, decorating information is known in the prior art. More specifically, by way of example, U.S. PreGrant Publication No. 2006/0085277 to Arnston discloses a method for selecting an item of home furnishings displayed in an accommodation includes accepting from a user an identification associated with AN accommodation. The furnishings displayed in the accommodation are determined and information identifying the displayed furnishings to the user is displayed. A selection of at least one of the home furnishings is selected from the user.

U.S. PreGrant Publication No. 2002/0099725 to Gordon discloses a system which allows a customer to manage a project through a website and determine how various changes to the project will affect cost, time and other variables. The system can also allow a customer to collaborate on a development project with installers, architects and other workers and to allow a customer to match a product to particular requirements. A kiosk system allows customer to view various products within the store, make selections through the kiosk and, potentially, match product to a particular requirement.

U.S. PreGrant Publication No. 2001/0047250 to Schuller, et al. discloses a computer-implemented method of visualizing a decorating project includes rendering an image of a building space, e.g., a room, that includes a number of structural objects such as doors, walls, and furniture. The structural objects may be portrayed in the rendered image with visual characteristics that are determined by decorative materials such as paint, fabric, or wallpaper. The decorative material associated with a particular structural object may be determined based on user input selecting an object's decorative material from a group of available decorative materials. The method may also include generating a listing of selected decorative materials (e.g., for use in a subsequent decorating session) and sending the listing to a purchasing system.

U.S. Pat. No. 7,249,063 to McMullen, et al. discloses a method for merchandising products in a home improvement or commercial construction retail store by introducing the seller's products adapted to perform the home improvement or commercial construction project through coordination of graphic elements such as color or number coding of the seller's products with an interactive display that conveys information regarding the project and aisle merchandising that directs the customer to the seller's products.

U.S. Pat. No. 7,277,572 to MacInnes, et al. discloses a method for generating and rendering a photorealistic three-dimensional (3D) perspective view of a 3D object selectively positioned within a 3D scene. A client is configured for communicably accessing a server, and includes a client application configured for scene editing and rendering, using a graphical user interface (GUI). The 3D scene may be selectively displayed in a plurality of views, and a 3D object may be retrieved from the server and imported into the 3D scene to generate a composite. The 3D object may also be manipulated within the composite for placement and orientation. A 3D image of the composite may then be rendered at the client and selectively reconfigured in real time.

U.S. Pat. No. 6,572,377 to Masters discloses a computerized expert system for providing interior design by allowing a homeowner to enter interior design requirements and select interior design treatments according to the homeowner's design requirements so that a grouping of compatible interior design treatments is provided for the homeowner to be used in decorating the homeowner's home.

U.S. Pat. No. 7,328,177 to Lin-Hendel discloses a method for enabling on-line purchasers to customize and personalize their purchasing options by prompting the customer to indicate customer preferences regarding merchandise and services to be purchased on-line. The method uses animation software, graphics and video input and output hardware and software and/or video streaming to (1) guide consumers in specifying customer preferences, (2) make purchasing recommendations to consumers, (3) narrow selections of merchandise or services, (4) determine the fit of merchandise, (5) configure and optimize various options of subsystems into a complete system, (6) layout, compose and/or animate merchandise or models wearing merchandise, and (7) display the fitted system of multiple items with the recommended and/or selected settings.

U.S. Pat. No. 6,343,264 to Fenton, et al. discloses a color selection process for assisting customers when shopping for floor, wall, or window coverings. The color selection process includes: (a) the creation of a digital and graphic computer database that classifies a store's or other entity's entire product inventory according to internally harmonious color families, and (b) using the database, computer graphics and a color room to give customers a preview of product(s) being considered.

U.S. Pat. No. 5,986,670 to Dries, et al. discloses a computer system for producing computer generated displays, including window-format displays permitting visualization of changes to a building or structure in an actual environment. The system provides a background display of digital images originating from either an image capture device or from other sources to which changes are to be made; a product catalog in the form of a database of objects, together with features in the computer system operable to record and store digital images of the objects as well as detailed information related to the objects within the database; and a mechanism to copy and removably place the object over the background.

### SUMMARY OF THE INVENTION

In an exemplary embodiment of the present invention, there is disclosed a method for providing a design by an internet based service provider comprises:
asking a client to provide information about home or office space;
providing to the service provider a type of design sought;
providing to the service provider a style preference; and
conveying to client via electronic means an interior or exterior design created by a professional designer, which can include décor related items for home or office space.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow diagram of an online based process where a client can provide photographs or video, along with stylistic choices and space dimensions to create a virtual room or virtual landscape webpage that will be used by a professional designer to create and display custom interior or exterior designs;

FIG. 2 is a flow diagram of a web accessed repository for personal interior/exterior design data where a user can store, share, retrieve, review interior and exterior design features, including text, photos, prices, voting, blog, advise and other data, and the system can make recommendations of products a user might wish to purchase to renew or replace his/her existing design features; and

FIG. 3 is a flow diagram of an internet based interface for a client to preview and purchase interior residential or commercial room designs from a selection of different pre-packaged or pre-rendered designs where, when a selection is made, the customer will be able to download information regarding the produces used, vendors where available, current pricing, and coordinating paint to use.

### DESCRIPTION OF THE PREFERRED EMBODIMENT

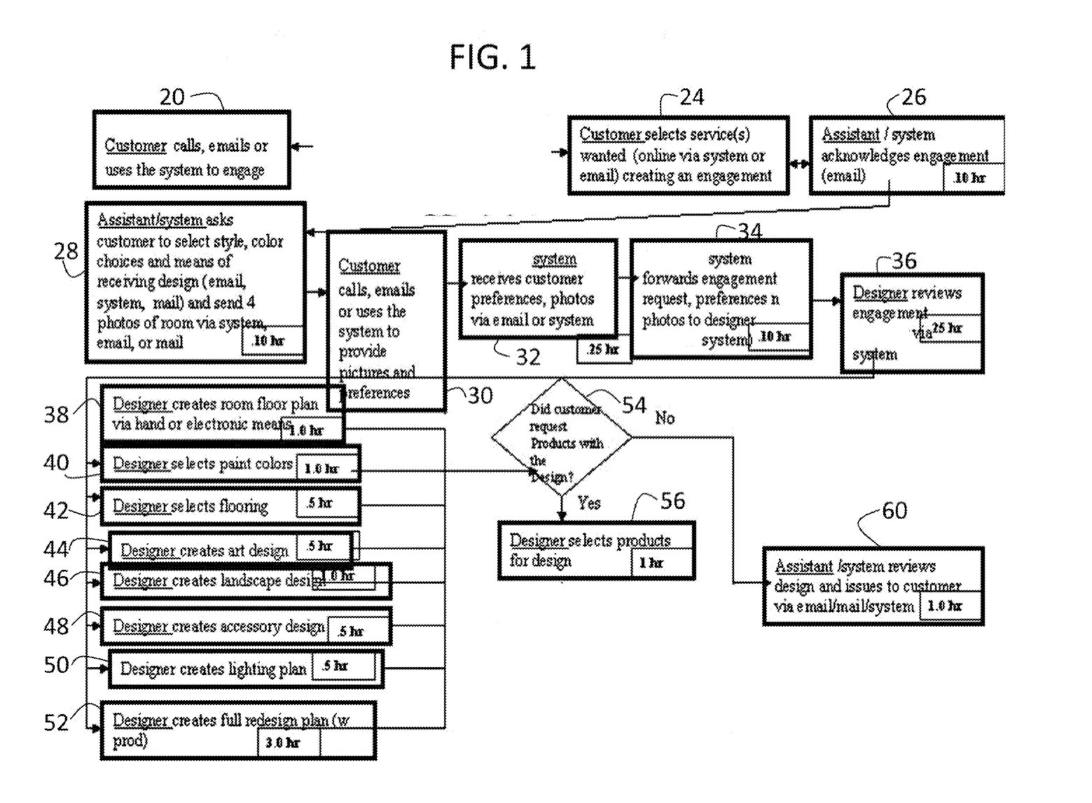

Referring to FIG. 1, there is disclosed a flow diagram of an online based process where a client can provide photographs or video, along with stylistic choices and space dimensions to create a virtual room or virtual landscape webpage. The information submitted by the client is accessible to a designer, and upon payment, the designer renders a design and delivers it to the client.

Additionally, a designer can research and provide pricing and purchase information for specific pieces used in the design. Each online virtual room or virtual landscape webpage allows a client to store information about the space such as future plans, custom paint colors, problems, etc., and share their designs with other users. Additionally, clients may use their web pages to organize various records, such as space dimensions, room function, budget, future plans, garden treatment information, and purchases on products or services.

A typical embodiment may encompass the following steps:
Client provides identifying information such as personal and information about the space
Client indicates type of design(s) sought
Client indicates style preferences
Professional designer renders design
Professional designer utilized the system to posts design to client's private web page
Additionally, the design need not be realized to be useful. Realtors may use this service to provide rendered designs of empty rooms in a house for sale.

Referring specifically to FIG. 1, at the start the customer calls, emails or uses the system to engage, block 20. Customer selects service(s) wanted (online via system or email) creating an engagement, block 24. The system acknowledges engagement (email), block 26, and the system asks customer to select style, color choices and means of receiving design (email, system, mail) and sends photos of room via system, email or mail, block 28.

The customer now calls, emails or uses the system to provide pictures and preferences, block 30. The system receives customer preferences, photos via email or system, block 32, and system forwards engagement request, preferences and photos to designer (via system) block 34. At block 36, the designer reviews engagement via system, and designer creates room floor plan or other design service via hand or electronic means, block 38; and selects paint colors, block 40; selects flooring, block 42; creates art and accessories design, block 44; creates landscape design, block 46; creates lighting plan, window treatment selection block 50; and creates full redesign plan, block 52.

If customer requested product selection with their design (YES), designer selects products for design, block 56, and adds pricing to the design, block 58, and assistant/system reviews design and product selections and sends to customer via email/mail/system, block 60. If customer did not request product selection for the design (NO), assistant/system reviews design and sends to customer via email/mail/system, block 60.

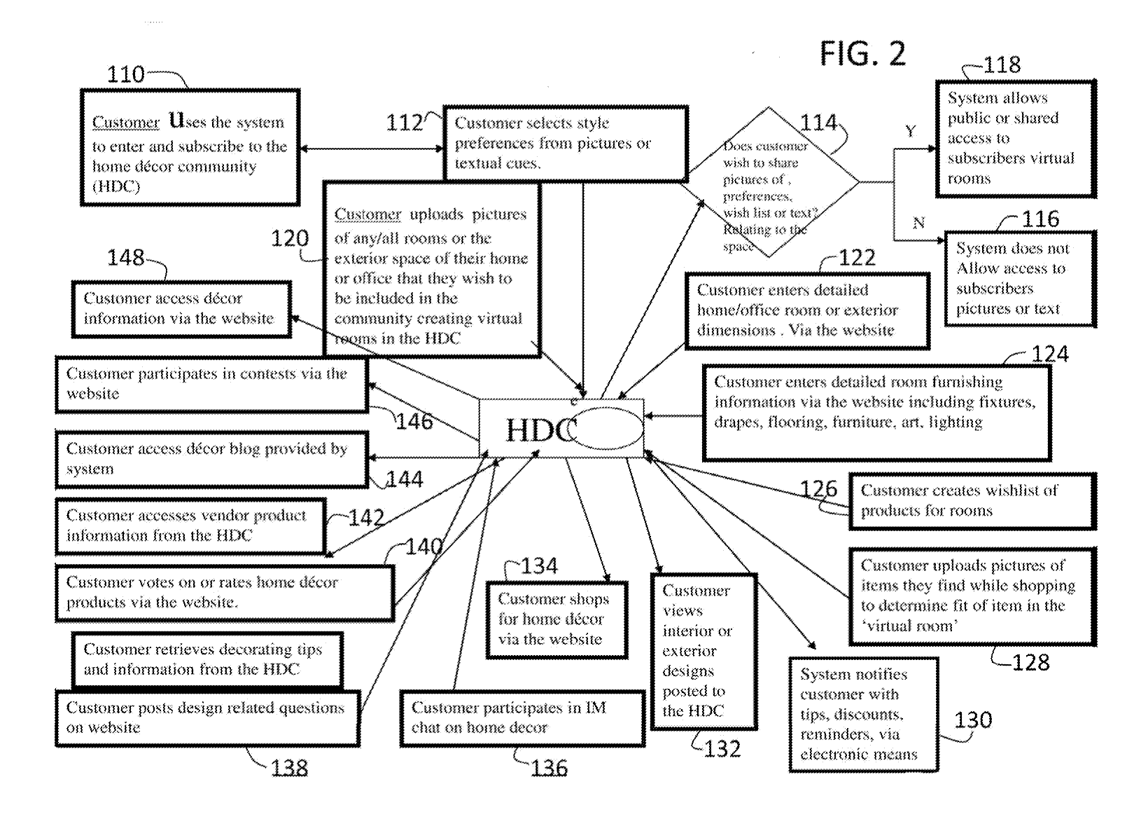

In another embodiment, and referring to FIG. 2, there is disclosed a flow diagram of a web accessed repository for personal interior/exterior design data where a user can store interior and exterior design features, including text, photos, prices, and other data, and the system can make recommendations of products a user might wish to purchase to renew or replace existing design features.

Broadly, this embodiment generally provides an online database and repository that allows users to enter data and photos indicating or depicting the dimensions of furniture, flooring, lighting, art, accessories, draperies, paint colors, fixtures, plantings, landscaping, architectural embellishments, and finishes of an interior/exterior room or space in their residential or commercial space. Items in the space may be marked by the user for renewal or replacement. The user may access this information at anytime via browser based device. Renewal options or replacement products and pricing will be identified and specified by the system. The user may also enter a dollar range defining the price he/she wishes to pay for an item to be renewed or replaced. Users may share and exchange information, pose questions, vote, participate in contests, with other users within the online community.

Often, consumers are unhappy with the existing interior or exterior dimensions, furniture, flooring, lighting, art, accessories, draperies, paint colors, fixtures, plantings, landscaping, architectural embellishments, and finishes. They will shop to purchase renewed or replacement items for same. The renewed or replacement items are not appropriate because the customer does not know the proper size, shape, style or dimension of a product to choose because they do not have a visual reference to the space available while shopping. The consumer forgets what it is they needed because of lack of convenient repository of that information. The consumer may find a suitable item but it is more expensive than they wish to pay.

Various inventive features are described below that can be used independently of one another or in combination with other features. However, any single inventive feature may not address any of the problems discussed above or may only address one of the problems discussed above.

An embodiment of a database will allow users to record existing interior and exterior residential and commercial dimensions, furniture, flooring, lighting, art, accessories, draperies, paint colors, fixtures, plantings, landscaping, architectural embellishments and finishes in the form of data or pictures so that they may be referenced at any time and any where the customer has a browser based device for access. The system will also make recommendations of products and pricing that might be suitable for the renewal or replacement of the identified items.

An exemplary method may encompass the following steps:
Customer accesses the space database
Customer provides pictures or data defining the design feature(s)
Customer indicates which items they wish to renew, replace or change
System offers product selection and pricing to renew or replace items
Customer can share access to portions of their space database with others
Customer may receive offers, hints, tips, discounts or design advice from other users
Customer can post questions, vote on décor, access vendor products, participate in contests or use chat/instant messaging with professional designers or other customers via video and/or the community.

An embodiment may include a space repository where the breadth of the repository can contain picture or data which defines any interior or exterior dimensions, furniture, flooring, lighting, art, accessories, draperies, paint colors, fixtures, plantings, landscaping and finishes in a residence or commercial space; and the ability to access the space repository anytime, anywhere via the device.

Referring specifically to FIG. 2, at the start, block 110, customer uses the system to enter and subscribe to the Home Decor Community (HDC) and the customer selects style preferences from pictures or textual cues, block 112. Designer uploads product selection and pricing to renew or replaced items. In the invention disclosed real designers are involved. At block 114, the customer can determine if he/she wishes to share pictures of preferences, wish list or text which relates to the space. If no (NO), the system does not allow access to subscribers pictures or text, block 116. If yes (YES), block 118, the system allows public or shared access to subscribers virtual rooms.

The customer now uploads pictures of any/all rooms or the exterior space of their home or office that they wish to be included in the community creating virtual rooms in the HDC, block 120. The customer now enters detailed home or office room or exterior dimensions via the website, block 122; enters detailed room furnishing information via the website including fixtures, drapes, flooring, furniture, art lighting, block 124; creates a wish list of products for the rooms, block 126; and uploads pictures of items they find while shopping to determine fit of items in the virtual room, block 128. The system notifies the customer with tips, discounts, reminders, via electronic means, block 130. The customer now views interior or exterior designs posted to the HDC, block 132, and the customer shops for home décor via the website, block 134. The customer may participate in IM chat on home décor, block 136. At this time the customer retrieves decorating tips and information from the HDC, block 138, and votes on or rates home décor products via the website, block 140. The customer accesses vendor product information from the HDC, block 142; accesses décor blog provided by the system, block 144; participates in contests via the website, block 146; and accesses décor information via the website, block 148.

The Home Décor Community allows for the storage of all of a customer's interior or exterior décor pictures and data, for example, paint colors, fixture models, carpet, furnishings, lighting, flooring, art and accessories, and exterior paints and plantings, landscapes, architectural embellishments, etc. for the customers viewing, manipulation, categorizing and sharing creating a virtual home, office or landscape. The community allows for storage of customer style preferences and indication of “wish list” items they want to renew or replace. Moreover, the community is a resource where the customer can participate in contests, vote, read tips, hints, advise and blogs, access vendor information, rate décor pictures, post décor and design questions, participate in décor related instant messaging or chat, receive discounts and coupons, etc.

As depicted in the figure, embodiments may also include interactions, where the customer shops for home décor, the customer participates in IM or chat, the customer retrieves decorating tips, the customer posts design related questions, the customer votes, the customer reads blog, etc. These are things that help make this a “community” rather than simply a database.

Embodiments may also include the concept of customer select style preferences.

Other embodiments may include the ability of the system to accept the user's indication of items that are to be renewed or replaced by the consumer, or the ability of the system to make recommendations of products and the pricing for items the consumer wishes to renew or replace or improve.

In an embodiment,
The customer creates an identity in the design system repository
The customer enters the data or pictures that define the existing interior or exterior dimensions, furniture, flooring, lighting, art, accessories, draperies, paint colors, fixtures, plantings, landscapings and finishes for their existing space in the repository
The customer may indicate items in the space repository that they wish to renew or replace or improve
The system may recommend products and pricing of items appropriate for the renewal or replacement of indicated items or improvement.

In an embodiment, at any time after creating an identity, the customer may access his/her personal space repository for use while shopping or using other means of replacing existing items. In addition, the customer may grant access to his/he space repository to others.

In an embodiment, a customer will access a web-based application that allows entry into the system pictures or data defining any interior or exterior dimensions, furniture, flooring, lighting, art, accessories, draperies, paint colors, fixtures, plantings, landscaping and finishes in a residence or office. The customer will identify components of the space that he/she wishes to renew or replace or improve.

The customer may reference his/her space repository at any time via a web-based device to generate lists of or facilitate the renewal or replacement of these interior or exterior items he/she wishes to renew or replace or improve.

He/she may also grant access to the repository to another party.

An embodiment of a web based application will create and store the customer's identify and hold the customer's space repository.

An embodiment can be used by a general contractor, landscape architect or interior designer to have a data or picture based reference to a customer's existing interior or exterior dimensions, furniture, flooring, lighting, art, accessories, draperies, paint colors, fixtures, plantings, landscaping and finishes item in a residence or office.

An embodiment of the invention can be used by an appraiser to evaluate a residential or commercial space.

An embodiment of the invention process can produce a 3D model from the dimensions entered into the commercial or residential interior or exterior repository.

An embodiment of the invention can generate a list or diagram including pictures or data that defines any interior or exterior, furniture, flooring, lighting, art, accessories, draperies, paint colors, fixtures, plantings, landscaping and finishes in a residence or commercial space that a customer wishes to renew or replace. A list or pictures of products and pricing of items recommended by the system for purchase can be produced.

An embodiment of the database can provide an individual with a single source to conveniently and quickly capture all aspects of their home or commercial space's interior or exterior such as photos and notes. They may also share access to the information with an interior designer, landscape architect, general contractor or other person to facilitate renewal or replacement, renovation or design plans. The system can also make recommendations for products and pricing of items that are appropriate to renew or replace items.

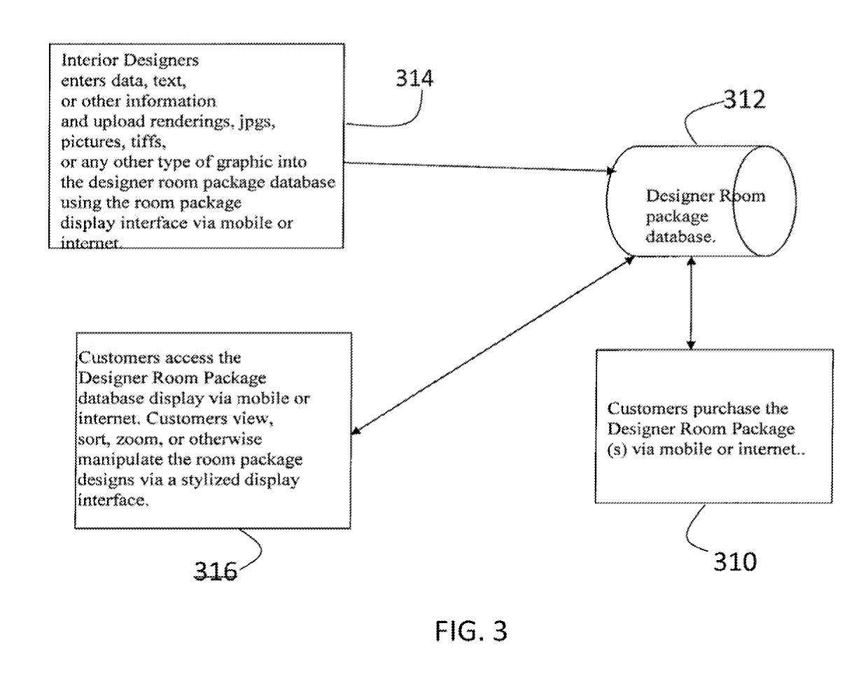

In another embodiment and referring to FIG. 3, there is disclosed a flow diagram of an internet based interface for a client to preview and purchase interior residential or commercial room designs from a selection of different pre-packaged designs where, when a selection is made, the customer will be able to download information regarding the products used, vendors where available, current pricing, and coordinating paint to use.

Designers populate the database with room designs which can include renderings, paint selections, furnishing selections, finishes, descriptive text, and other design characteristics. Each design can be categorized by style, room function, and room size.

In use, a customer can search and sort for designs based on a desired room function, room size, design style, color palette, or other distinguishing characteristic. Customers can then select and purchase any of the pre-packaged room designs.

Broadly, an exemplary embodiment of the present invention provides a computer enabled method for previewing and purchasing interior residential or commercial room designs, including the steps of providing a software interface and database disposed to allow entry and storage of a plurality of characteristics of a design; uploading pictures, texts, renderings, or graphics to a pre-packaged room designs database; displaying the prepackaged room designs to a customer, wherein the customer can view or sort the display by any of the characteristics of the design; sorting, viewing, and selecting the pre-packaged room designs by the customer; and receiving detailed information of the full pre-packaged room design via a mobile device or the internet.

Interior design customers/clients want to see what the end result of a design looks like before they purchase or install it. Also, interior designs created by professional, educated, or accredited designers are perceived as being time consuming to arrange and expensive. The software of the embodiment can allow clients to see, via the internet or mobile technologies, a variety of pre-packaged professional interior room designs before buying them. It will also provide designers with a virtual warehouse for entering and uploading interior designs for display via mobile or internet technologies.

Currently, professional interior designers display their designs in pieces and parts on what is known as a material board. This is a deliverable that must be physically received by the client before it can be viewed. The embodiment can be used to display for the customer the material board and full room design via mobile or internet. Also, designs can be displayed by style, room function, room size, or any other relevant design characteristics, i.e., finish, color palette, texture etc. and incorporate products and materials from a variety of vendors rather than any single vendor.

Referring specifically to FIG. 3, a customers purchases the designer room package(s) via mobile or internet, block 310, from designer room package database, block 312. Interior designers enter data, text, or other information and upload renderings, jpgs, pictures, gifs, video or any other type or graphic into the designer room package database using the room package display interface via mobile or internet, block 314. Customers access the designer room package database display via mobile or internet, and view, sort, zoom, or otherwise manipulate the room package designs via a stylized display interface, block 316.

According there is disclosed a method which can allow a customer to preview and purchase interior residential or commercial room designs that are of different style, size, function combinations, and select them for purchase. Once selected, the customer can receive via web or mobile means the products, vendors, pricing, and coordinating paint colors. The method disclosed can comprise a software interface and design database that can provide a place for designers to enter and store renderings, paint selections, furnishing selections, finishes, descriptive text, and any other characteristic of a design. The method can also allow the designer to categorize the design by style, room function and room size. The designer can enter design data and text and upload pictures or graphics of furnishings and upload paint chips and save these to the pre-packaged room database. Based on the room style, function and size, or other design characteristic, the software application can display pre-packaged room designs for clients and, for example, excluding pricing, paint colors and vendor information. The customer may view or sort the displays by room function, style, size, color palette or other distinguishing characteristic. The customer may then select and purchase the pre-packaged room designs. The customer can receive, via mobile devices, videos or the internet, the full pre-packaged room design including vendor information, pricing, and paint colors.

Once the design is in the database, the application can use design characteristics such as room function, style, size or any other relevant design characteristic to allow the client to inquire the database for design packages. The customer may view, sort, or otherwise manipulate the design packages. The customer may purchase any of the design packages.

Internet or mobile technology can be used to allow interior designers to enter data and upload pictures, renderings, and graphics to a database for storage and display. The professionally created room packages can be displayed from the database. A customer can sort, review, select or otherwise manipulate the room packages for best viewing. The customer may purchase a complete room package from those on display.

The present invention produces and displays, via mobile or internet technologies, professional interior design room packages that include furnishings, lighting, art and accessories, flooring, and window treatments and any other relevant design components. The technology of the present invention may also be used in the field of landscape design.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method for providing an interior or exterior space design by an internet based service provider comprises:
allowing a client to store information about interior or exterior home or office space;
providing to the service provider a type of design sought; or the ability to purchase service;
providing to the service provider a style preferences, room function or other specifics; and
conveying to client via electronic means an interior or exterior design created by a professional designer, which can include décor related items for home or office space.

2. The method of claim 1 wherein the information provided by the client about home or office is via at least one picture, a link, text, independent application, mobile or a video.

3. The method of claim 2 wherein the information is sent via the internet or electronic means.

4. The method of claim 3 wherein the client creates and can access at any time a virtual room or virtual landscape webpage for storing information about the home or office.

5. The method of claim 4 wherein the virtual room or virtual landscape webpage can be used to store future plans, functions, style preferences, problems, wish lists, questions or custom paint colors information about the home or office.

6. The method of claim 4 wherein the virtual room or virtual landscape webpage can be used by the client to share plans stored on the webpage with others.

7. The method of claim 6 wherein the client is a realtor that uses the webpage to request or receive rendered designs of empty rooms in a house for sale or rent.

8. The method of claim 6 wherein the virtual room or virtual landscape webpage is used to obtain bids on services, purchase designs or to purchase products.

9. The method of claim 1 wherein the interior or exterior design includes décor related items.

10. The method of claim 9 wherein the décor related services or products are selected from the group consisting of, furniture, flooring, lighting, art, accessories, draperies, paint colors, fixtures, plantings, landscaping or finishes.

11. The method of claim 1 wherein the information that the client provides about the home or office relates to items which are to be changed or replaced.

12. The method of claim 11 wherein the service provider provides a bid for making the change or replacement requested.

13. The method of claim 4 wherein client can share access to portions of their virtual room or virtual landscape with others.

14. The method of claim 1 wherein the service provider can make recommendations of products a client may wish to purchase to renew or replace existing design features.

15. The method of claim 1 wherein the service provider conveys to the client interior or commercial room designs from a selection of different designs that the client can preview and purchase.

16. The method of claim 15 wherein, after making a selection of a room design, the client can download information regarding the products selected, vendors where available or current pricing.

17. The method of claim 15 wherein the client can search for designs based on a desired room function, size, style or design budget.

18. The method of claim 15 wherein the client can request what color paint to use.

19. The method of claim 15 wherein the client may share or exchange information, chat, vote, participate in contests, post questions, with other users within the online community.
